(19) United States
(12) Patent Application Publication
(10) Pub. No.: US 2025/0301238 A1
(43) Pub. Date: Sep. 25, 2025

(54) COMBINED IMAGING AND DEPTH MODULE

(71) Applicant: Meta Platforms Technologies, LLC, Menlo Park, CA (US)

(72) Inventors: Gregory Cohoon, Sunnyvale, CA (US); Hod Finkelstein, Albany, CA (US); Harish Venkataraman, Buckley, WA (US)

(21) Appl. No.: 19/088,239

(22) Filed: Mar. 24, 2025

Related U.S. Application Data
(60) Provisional application No. 63/569,718, filed on Mar. 25, 2024.

(51) Int. Cl. H04N 25/705; G01S 7/4865; G01S 17/89; H04N 23/11; H04N 23/56; H04N 23/698; H04N 25/532; H04N 25/771; H04N 25/79

(52) U.S. Cl. CPC H04N 25/705; G01S 7/4865; G01S 17/89; H04N 23/11; H04N 23/56; H04N 23/698; H04N 25/532; H04N 25/771; H04N 25/79

(57) ABSTRACT

A depth sub-frame is captured with a first region of depth pixels configured to image a first zone of a field illuminated by near-infrared illumination light. A visible-light sub-frame is captured with a second region of image pixels that is distanced from the first region of the depth pixels. The second region of the image pixels is configured to image a second zone of the field while the first region of the depth pixels images the first zone of the field while the near-infrared illumination light illuminates the first zone.

### CROSS-REFERENCE TO RELATED APPLICATIONS

This application claims priority to U.S. provisional Application No. 63/569,718 filed Mar. 25, 2024, which is hereby incorporated by reference.

### TECHNICAL FIELD

This disclosure relates generally to imaging, and in particular to combining depth and visible light images.

### BACKGROUND INFORMATION

Combining Red, Green, and Blue (RGB) images and depth data is desirable for a variety of applications including automotive, robotics, and wearables. By combining the RGB images and depth data, a detailed three-dimensional (3D) representation of objects and environments can be generated. For automobiles and robots, the 3D representation may aid in the automobile or robot navigating the environment. In the wearables context, the 3D representation can be used to provide pass through images and object detection to a user of a Mixed Reality (MR) or Virtual Reality (VR) headset, for example.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1A illustrates an example imaging and depth system for imaging and depth sensing of an environment, in accordance with aspects of the disclosure.

FIG. 1B illustrates a portion of an example imaging and depth sensor having Single Photon Avalanche Diode (SPAD) pixels interspersed with Complimentary Metal-Oxide-Semiconductor Image Sensor (CIS) pixels, in accordance with aspects of the disclosure.

FIG. 1C illustrates an example illumination module including light sources, in accordance with aspects of the disclosure.

FIG. 2A illustrates example Depth acquisitions and visible light acquisitions, in accordance with aspects of the disclosure.

FIG. 2B illustrates an example imaging and depth sensor including four regions arranged in quadrants, in accordance with aspects of the disclosure.

FIG. 2C illustrates a flow chart of an example process of capturing depth data and image data with a combined imaging and depth module, in accordance with aspects of the disclosure.

FIG. 3 illustrates another embodiment of example depth acquisition sub-frames and visible light imaging acquisition sub-frames, in accordance with aspects of the disclosure.

FIG. 4 illustrates yet another embodiment of example depth acquisition sub-frames and visible light imaging acquisition sub-frames, in accordance with aspects of the disclosure.

FIG. 5 illustrates an example macropixel having a SPAD depth pixel interspersed with CIS image pixels, in accordance with aspects of the disclosure.

FIG. 6 illustrates corresponding instantaneous fields of view (iFoV) of pixels in 2×2 array of macropixels, in accordance with aspects of the disclosure.

FIG. 7 illustrates a SPAD pixel surrounded by CIS macropixels, in accordance with aspects of the disclosure.

FIG. 8A illustrates an example imaging and depth sensor including multiple layers, in accordance with aspects of the disclosure.

FIG. 8B illustrates a top view of a SPAD and photodiodes of CIS pixels that may be included in an imaging and depth sensor, in accordance with aspects of the disclosure.

FIG. 9A illustrates another example imaging and depth sensor including multiple layers, in accordance with aspects of the disclosure.

FIG. 9B illustrates an example compound pixel having four SPAD pixels arranged in a 2×2 configuration with CIS pixels around the 2×2 configuration, in accordance with aspects of the disclosure.

FIG. 10 illustrates an example temporal operation of a SPAD pixel or group of pixels, in accordance with aspects of the disclosure.

FIG. 11 illustrates another example imaging and depth sensor including multiple layers, in accordance with aspects of the disclosure.

FIG. 12 shows that imaging and depth sensors may be placed on a head-mounted display (HMD) at a location that approximates where a pupil of an eye would be looking through. when a user is wearing the HMD, in accordance with aspects of the disclosure.

### DETAILED DESCRIPTION

Embodiments of a combined imaging and depth module are described herein. In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In some implementations of the disclosure, the term “near-eye” may be defined as including an element that is configured to be placed within 50 mm of an eye of a user while a near-eye device is being utilized. Therefore, a “near-eye optical element” or a “near-eye system” would include one or more elements configured to be placed within 50 mm of the eye of the user.

In aspects of this disclosure, visible light may be defined as having a wavelength range of approximately 380 nm-700 nm. Non-visible light may be defined as light having wavelengths that are outside the visible light range, such as ultraviolet light and infrared light. Infrared light having a wavelength range of approximately 700 nm-1 mm includes near-infrared light. In aspects of this disclosure, near-infrared light may be defined as having a wavelength range of approximately 700 nm-1.6 μm.

In certain contexts, it is desirable to have simultaneous, co-registered high resolution red-green-blue (RGB) (or other multispectral with 1 or more band) imaging and a direct time-of-flight (dToF) or indirect time-of-flight (iToF) depth sensing. The Time-of-Flight (ToF) sensing may utilize Single Photon Avalanche Diodes (SPADs) that are configured to sense narrow-band near-infrared light.

In one example, a mixed reality (MR) device aims to reproject the RGB images collected by one or two cameras which are offset from the eyes to the position of the eyes or in proximity thereto in order to place synthetic/virtual objects on top of one or two images displayed on a display. In order to reproject the images, the depth of points in the image may be assessed via a dToF depth sensor, for example. However, because the dToF sensor and the image sensor (e.g. complementary metal-oxide-semiconductor “CMOS” image sensor) are not co-located, some regions in the field of view may be obstructed from one or both sensors. In addition, because the two sensors are not co-located, one image needs to be projected onto the other. This requires power-hungry computation and may result in latency. Furthermore, if the 2D image data and 3D depth data are not acquired at the same time (or almost the same time), the imaged objects may move between acquisitions and incorrect depths may be assigned to objects, thus creating distortions in the eye-projected passthrough display.

In another example, an autonomous car needs to collect high-resolution color images as well as depth information in order to assess the car's position as well as other objects, and to identify these objects within an environment. The depth frame needs to be projected onto the RGB frame or vice versa, and this needs to be performed at very low latencies in order to enable the car to take action on time. However, this data reprojection or fusion is computationally intensive and takes time, resulting in undesirable latencies and power consumption.

There are problems which may be addressed in order to enable co-located and simultaneous (or at least close to simultaneous) acquisition of RGB and Depth data. The problems include spectral cross-talk between RGB pixels and Depth pixels and colocation of the circuitry required to operate RGB and Depth pixels. In the disclosure, the terms “imaging pixel(s),” “RGB pixels” or “CIS” (referring to “CMOS Image Sensor”) may be used to refer to capturing RGB imaging data and “depth pixel(s)” or “SPAD” may be used to refer to capturing Depth data from near-infrared light. The imaging pixels or CIS pixels may also capture other bands of light (e.g. near-infrared) other than, or in addition to, RGB light.

RGB pixels typically need to sense photons approximately in the 450-700 nm (visible) range. Active-depth pixels typically need to sense photons in the 850 nm, or 905 nm or 940 nm range, which are generated by an illuminator. If visible photons hit the depth detector, they may cause saturation of these pixels or degradation of their signal-to-noise ratio (SNR). If near-infrared (NIR) photons become incident on the RGB detectors (e.g. CMOS pixels), they may cause a background signal and increased noise.

dToF depth modules often utilize SPADs (Single Photon Avalanche Diodes). In many applications, the SPAD device may either get saturated by ambient light, unless it is sufficiently spectrally filtered, or the SNR of the temporal histogram used to generate depth information is too low, due to the ambient photon shot noise. Typically, ToF sensors utilize a narrow bandpass filter in order to sufficiently reject out of band ambient light. However, this may not be possible when an RGB pixel array is co-located on the same die because the RGB pixels must sense this out-of-band light. The problem is exacerbated by the fact that typically ToF devices use active illumination in the NIR, e.g., 850 nm or 905 nm or 940 nm. Silicon is typically far less sensitive to these wavelengths than to visible wavelengths (e.g. 4% quantum efficiency at 940 nm vs 40% at 530 nm) so ten 940 nm photons would need to offset the signal generated by a single 530 nm photon.

Another potential issue is infrared light leakage into the RGB pixels. Typically, an infrared-blocking filter is placed in front of an RGB sensor to block this light. However, because the SPADs must sense infrared photons, at least a spectral band of these photons must be allowed to impinge on the sensor. The effect of infrared photons on the pixels can either be a) accumulation in the RGB pixels, thereby decreasing their dynamic range; b) Adding a background level of charge, so that otherwise-darker images seem brighter; c) Adding photon shot noise to the RGB pixels so they appear noisier; and/or d) Adding varying amounts of shot noise to each of the red, green, and blue pixels, thereby distorting the color accuracy of the sensor.

Yet another potential issue is that the processing transistors, timing circuitry, and interconnect network of each of the imaging pixels in the array and the SPAD pixels require significant silicon real-estate, and this circuitry is unique to the imaging pixels and SPAD pixels. Thus co-locating both on the same die, or even on a 2nd tier die (e.g., attached via in-pixel bonding in a wafer stack) typically is insufficient to support a mixed SPAD and CIS array on a single or a 2-stack die.

Specifically, when operated in time-correlated single-photon counting mode (TCSPC), the processing circuitry required to generate time-of-arrival (TOA) data per pixel is large. This circuitry typically includes quenching and recharging circuits, timing circuits, a relatively large memory array, and control and readout circuitry. Typically the area required for this circuitry is larger than the typical SPAD device area. Therefore, when the SPAD and processing circuitry are stacked, the processing circuitry must be shared between several SPAD pixels, e.g., all SPADs in a row or SPADs in a sub-region of the overall array. When the processing circuitry is shared, not all SPADs can operate simultaneously (“global shutter”) and the ability to activate the array in dynamically reconfigurable regions of interest (ROI) is limited.

Embodiments of the disclosure include a device which facilitates sufficiently-concurrent and co-registered higher-resolution RGB (or multispectral) imaging with lower resolution depth imaging.

A Red-Green-Blue-Depth “RGBD” module or system includes a dToF modulated-light transmitter (Tx), an RGBD receiver/sensor (Rx), a controller, and processing circuitry. These may be co-located in the same package, or in the same module, or in separate modules which are electrically interconnected.

The Tx may include a laser driver which generates electrical signals, such as electrical current pulses, e.g., with nanosecond-range duration. It may also contain optical emitters such as edge-emitting lasers or vertical-cavity surface-emitting laser (VCSELs), which may emit light in the NIR range, e.g., 850 nm or 940 nm. The emitted light may be coupled to Tx optics, such as diffusers, diffractive optical elements (DOEs), metaoptics, which shape the Tx beam. Beam shapes may resemble a top-hat, a dot array, a line array, or other patterns.

The Rx may include a collection optics, such as a collection lens, collecting light from essentially, or at least, the illuminated field. In some embodiments, the collection field of view (FOV) may be larger than the Field of Illumination (FOI). The Rx module may also contain at least one module-level optical filter. In one embodiment, the filter's passband may incorporate both the visible range and the Tx NIR wavelength. In one embodiment, the filter may have 2 passbands—one incorporating the visible range, and one incorporating the Tx NIR wavelength, but blocking a sufficiently large portion of the spectral range between them and above the Tx NIR wavelength.

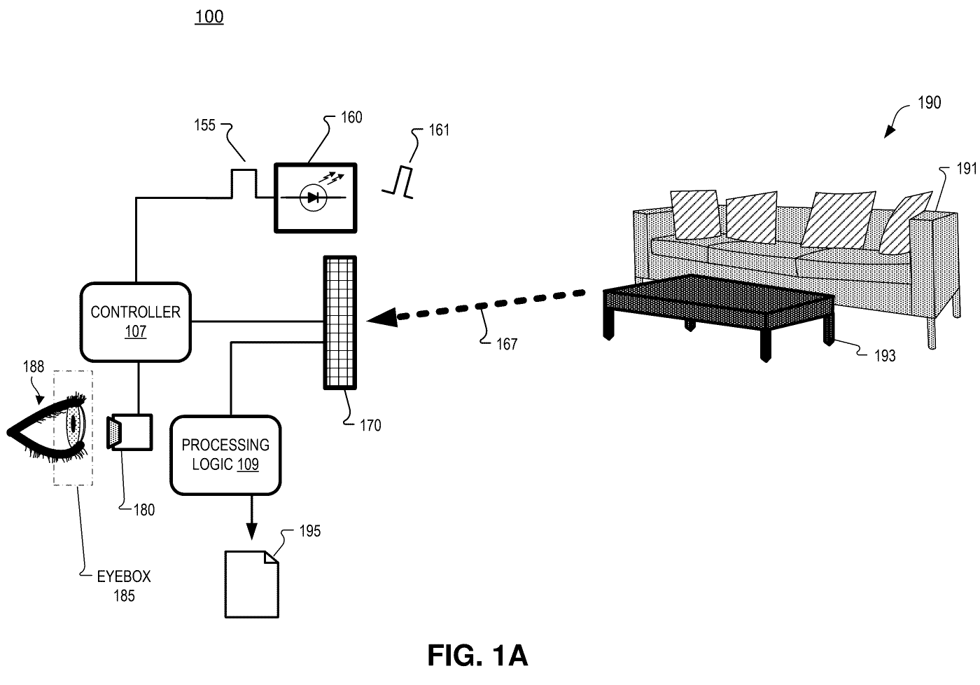

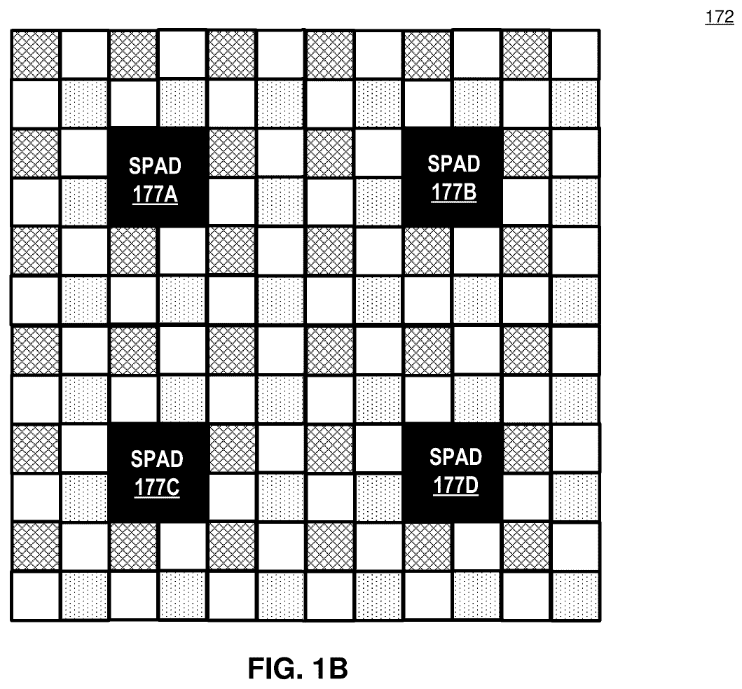

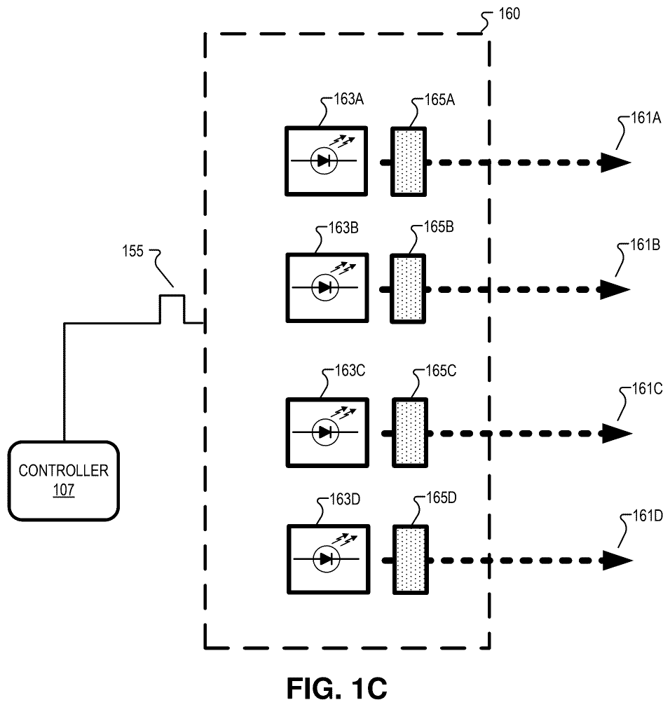

In one embodiment, the controller times the firing of the laser pulses and the activation of the CIS and SPAD pixels. The timing ensures that a sufficient SNR is achieved for depth acquisition and that light leakage between the visible and NIR channels is sufficiently low. These and other embodiments are described in more detail in connection with FIGS. 1A-12.

FIG. 1A illustrates an example imaging and depth system 100 for imaging and depth sensing of an environment 190, in accordance with aspects of the disclosure. System 100 may be included in an HMD, smartglasses, or other contexts such as robotics, automotive, and/or gaming. In the illustration of FIG. 1A, environment 190 includes a couch 191 (with striped throw pillows) situated with a coffee table 193.

System 100 includes an illumination module 160, a combined imaging and depth sensor 170, controller 107, processing logic 109, and optional eye-tracking module 180. Eye-tracking module 180 may be configured to generate eye-tracking data by imaging an eye 188 in an eyebox region 185. In some implementations, illumination module 160 may illuminate environment 190 with pulsed near-infrared illumination light 161. Illumination module 160 may include the features of the ToF modulated-light transmitter (Tx) described above. Illumination module 160 may include one or more lasers or LEDs as light sources to generate illumination light 161. In some implementations, each light source and/or groups of light sources are addressable (i.e., may be controlled independent from other light sources and/or groups of light sources). In some implementations, the illumination module 160 may also include an optical assembly that can be used to direct light from illumination module 160 to specific regions within the environment 190. In some implementations, illumination module 160 may emit flood illumination, a pattern (e.g., dots, bars, etc.), or some combination thereof. Illumination module 160 may be configured to generate ToF light pulses (light 161) in response to a driving signal 155 received from controller 107.

In the illustrated example, illumination module 160 emits ToF light pulses 161. Illumination module 160 is communicatively coupled with controller 107. Controller 107 is communicatively coupled to the combined imaging and depth sensor 170. Imaging and depth sensor 170 may be co-located with illumination module 160 and configured to capture ToF return signals 167 that are reflected (or scattered) from objects in the environment 190 that receive illumination light 161. A variable delay line may be connected to the controller, laser driver, or the timing circuitry of the SPAD receiver, and may be utilized in a calibration step to calibrate against temporal signal offsets such that time signatures from the SPAD may be translated to physical distance traversed by the light from emission (light 161 emitted by illumination module 160) to reception (light 167 received by combined imaging and depth sensor 170).

Imaging and depth sensor 170 may include both CIS pixels and SPAD pixels. FIG. 1B illustrates an example portion 172 of an example imaging and depth sensor having SPAD pixels 177A-177D interspersed with CIS pixels, in accordance with aspects of the disclosure. The rectangles smaller than SPAD pixels 177A-177D are the CIS pixels, in FIG. 1B. The CIS pixels and SPAD pixels may be arranged into repeatable macropixels having depth pixels (e.g. SPADs) interspersed with image pixels (e.g. CMOS pixels), for example.

The processing logic 109 illustrated in FIG. 1A may be configured to receive imaging data and depth data from combined imaging and depth sensor 170. Processing logic 109 may generate fused data 195 that includes (or is derived from) the imaging data and the depth data received from combined imaging and depth sensor 170. The fused data 195 may be provided to another processing unit (not illustrated) for further downstream processing.

In the context of this disclosure, discussion of a “VCSEL array” may also be generalized to mean an array of emitters (e.g. to generate illumination light 161) and “imaging array” may mean an array of CIS and SPAD pixels. A VCSEL array may include one or more sub-arrays, each illuminating a zone of a FOI. A SPAD array may include one or more sub-arrays, each imaging a zone of a FOV correlated to one or more FOIs zones.

FIG. 1C illustrates an example illumination module 160 including light sources 163A-163D (collectively referred to as “light sources 163), in accordance with aspects of the disclosure. The light sources 163 may be VCSELs or LEDs, for example. FIG. 1C shows that example illumination module 160 includes four light sources 163, but more or fewer light sources may be included in the illumination module 160 of FIG. 1C. FIG. 1C shows that each light source 163 may have an optical element to shape the illumination light. For example, optical elements 165A, 165B, 165C, and 165D shape the illumination light 161A, 161B, 161C, and 161D emitted from light sources 163A, 163B, 163C, and 163D, respectively. In one embodiment, each light source 163 has a microlens to sufficiently collimate its output (illumination light). The optical elements 165A, 165B, 165C, and 165D (collectively referred to as optical elements 165) may direct the illumination light to different zones in the FOI. The optical elements 165 may be a collimator, a diffuser, a line generator, a dot generator, or a combination of the above. The optical elements 165 may be implemented by using Diffractive Optical Elements or meta surfaces, for example. The optical elements 165 may be implemented as refractive optical elements such as prisms or lenses.

In one embodiment, the whole array of light sources 163 fires at once to achieve flood illumination. In one embodiment, the array of light sources 163 fires sequentially, e.g., one or more columns at a time, and each column illuminates one segment or zone of the FOI. In one embodiment, the array of light sources 163 is fired to illuminate one zone at a time.

Returning again to FIG. 1A, combined imaging and depth module 170 may incorporate a module-level spectral filter placed over the imaging pixels and depth pixels. For example, the module-level spectral filter may be a dual-passband filter allowing only RGB light and light centered around a narrow band (e.g. 930 nm-950 nm) of the illumination light 161 (if illumination light 161 was centered around 940 nm, for example). Combined imaging and depth module 170 may incorporate one or more lenses to collect the light from the field of view and to focus them onto the RGB+D pixels. Imaging and depth module 170 may incorporate an array of spectral filters (e.g. of different spectral transmittance characteristics) for each type of pixel—R, G, B and D. The RGB filters may sufficiently block IR light and the IR filter (over the Depth pixels) may sufficiently block ambient light.

In one embodiment, the RGB filter out-of-band rejection ratio is insufficient to block the IR light. When the array of light sources 163 illuminates one zone of the FOI, the Depth pixels image that zone but the CIS array may image a sufficiently distant zone such that reflected IR light (e.g. light 167) mostly does not reach the active RGB pixels. An IR pass filter rejects ambient light from the SPAD pixels.

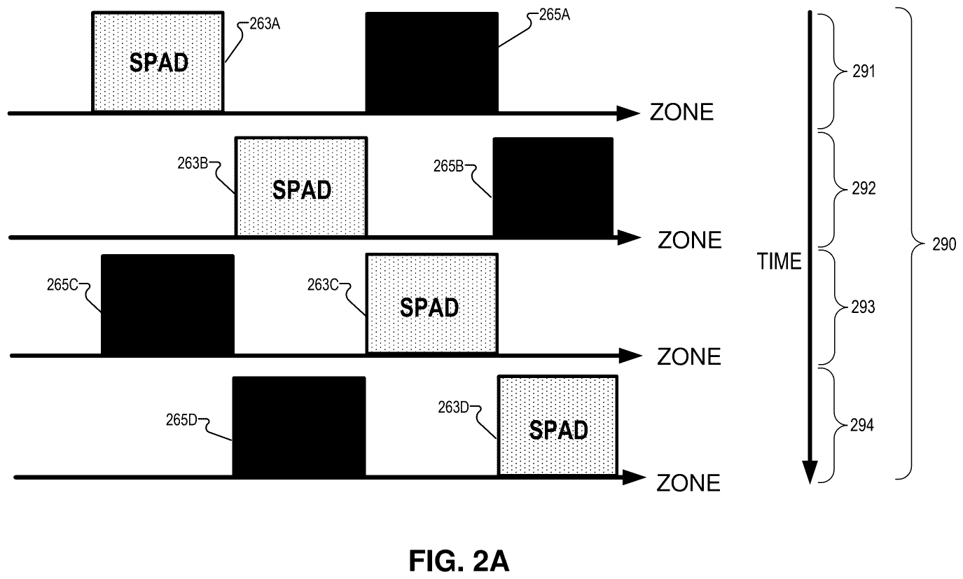

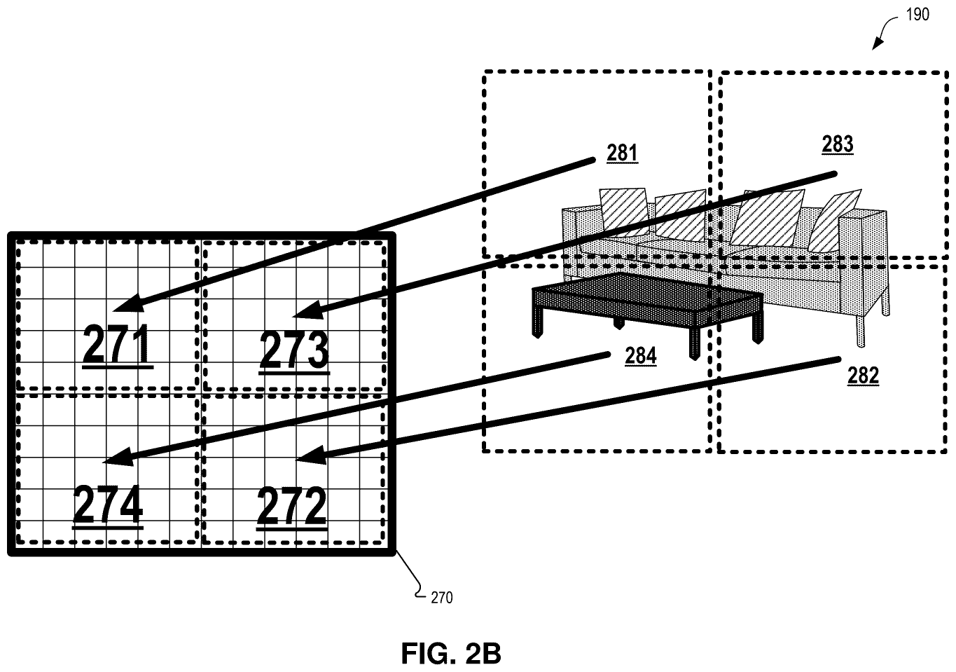

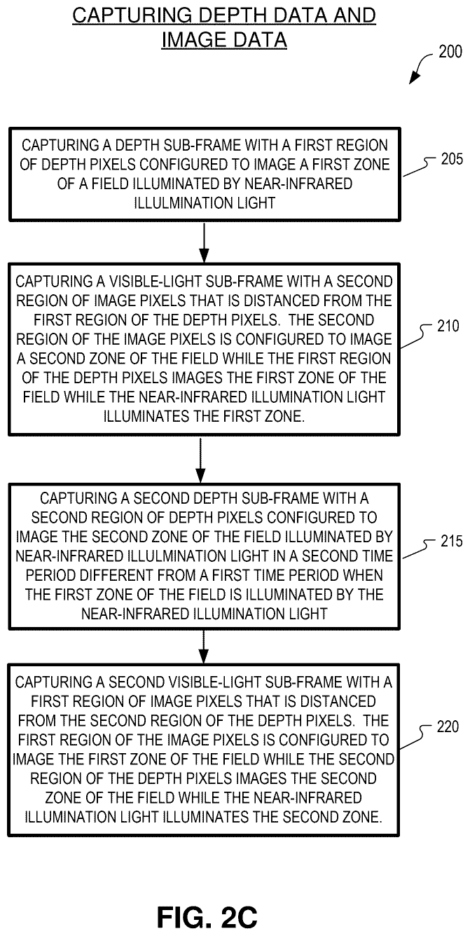

FIG. 2A illustrates example Depth (e.g. SPAD) acquisitions 263A-263D and visible light acquisitions 265A-265D, in accordance with aspects of the disclosure. It should be noted that the duration of a Depth acquisition 263A-263D and visible light acquisition 265A-265D need not be the same. Nor do the duration of all zonal acquisition of one type need to be the same—duration can be longer where a longer acquisition is required, for example due to lower-power active illumination (e.g., in the periphery) or due to higher desired precision (e.g., range precision in the center of the field of view).

During a Depth acquisition, light sources 163 fires/emits multiple pulses of illumination light 161 and the SPAD array in the combined sensor 170 performs multiple time-of-arrival acquisitions. Techniques such as Time-Correlated Single-Photon Counting (TCSPS) may be utilized for the Depth acquisitions, for example. During the image acquisition, the CIS pixels integrate optical flux and performs acquisition steps such as Correlated Double Sampling (CDS), for example. While Depth and RGB image data (from the same zone) are not captured concurrently, the delay between acquisitions from the same zone are shorter than the duration of a frame, and can be made much shorter than a frame, thus reducing distortions in the downstream user experience.

FIG. 2B illustrates an example imaging and depth sensor 270 including four regions arranged in quadrants, in accordance with aspects of the disclosure. Each region of imaging and depth sensor 270 may have SPAD pixels interspersed with CIS pixels, as in FIG. 1B. The features of sensor 270 may be implemented in imaging and depth sensor 170. In an example, region 271 of sensor 270 is configured to image zone 281 of environment 190, region 272 of sensor 270 is configured to image zone 282 of environment 190, region 273 of sensor 270 is configured to image zone 283 of environment 190, and region 274 of sensor 270 is configured to image zone 284 of environment 190. Hence, the zones of the field/environment that are shown as imaged in the timing diagram of FIG. 2A may have a corresponding region of the imaging and depth sensor 170/270 that is imaging the zone.

By way of illustration, the first region 271 (e.g. upper left quadrant) of the combined imaging and depth sensor 270 may capture IR data using SPAD pixels in first region 271 while illumination module 160 illuminates first zone 281. While the SPAD pixels in first region 271 capture IR data from first zone 281, CIS pixels in another region (e.g. second region 272 in lower right quadrant of the combined imaging and depth sensor 270) may capture RGB data from second zone 282. Notably, the first region 271 and the second region 272 may be diagonal from each (also known as kitty-corner) from each other and thus the optical crosstalk between SPAD pixels in first region 271 and CIS pixels in second region 272 will be significantly reduced, if not almost eliminated.

In the example timing diagram of FIG. 2A, frame 290 includes sub-frames 291, 292, 293, and 294. Sub-frames 291 292, 293, and/or 294 may be captured within 20 ms of each other. Sub-frames 291 292, 293, and/or 294 may be captured within less than 20 ms of each other. In sub-frame 291, Zone 1 (e.g. zone 281) may be illuminated by NIR illumination light and Depth data is acquired by SPAD pixels in region 271 of sensor 270, as indicated by Depth acquisition 263A. CIS pixels in region 272 of sensor 270 may capture RGB image data reflected/scattered from zone 282 in sub-frame 291, as indicated by visible light acquisition 265A. Depth acquisition 263A and visible light acquisition 265A overlap in time, but don't necessarily take the same amount of time for the respective acquisitions.

In sub-frame 292, Zone 3 (e.g. zone 283) may be illuminated by NIR illumination light and Depth data is acquired by SPAD pixels in region 273 of sensor 270, as indicated by Depth acquisition 263B. CIS pixels in region 274 of sensor 270 may capture RGB image data in sub-frame 292, as indicated by visible light acquisition 265B. Depth acquisition 263B and visible light acquisition 265B overlap in time, but don't necessarily take the same amount of time for the respective acquisitions.

In sub-frame 293, Zone 2 (e.g. zone 282) may be illuminated by NIR illumination light and Depth data is acquired by SPAD pixels in region 272 of sensor 270, as indicated by Depth acquisition 263C. CIS pixels in region 271 of sensor 270 may capture RGB image data in sub-frame 293, as indicated by visible light acquisition 265C. Depth acquisition 263C and visible light acquisition 265C overlap in time, but don't necessarily take the same amount of time for the respective acquisitions.

In sub-frame 294, Zone 4 (e.g. zone 284) may be illuminated by NIR illumination light and Depth data is acquired by SPAD pixels in region 274 of sensor 270, as indicated by Depth acquisition 263D. CIS pixels in region 273 of sensor 270 may capture RGB image data in sub-frame 294, as indicated by visible light acquisition 265D. Depth acquisition 263D and visible light acquisition 265D overlap in time, but don't necessarily take the same amount of time for the respective acquisitions.

FIG. 2C illustrates a flow chart of an example process 200 of capturing depth data and image data with a combined imaging and depth module, in accordance with aspects of the disclosure. The order in which some or all of the process blocks appear in process 200 should not be deemed limiting. Rather, one of ordinary skill in the art having the benefit of the present disclosure will understand that some of the process blocks may be executed in a variety of orders not illustrated, or even in parallel. In some implementations, controller 107 and/or processing logic 109 of FIG. 1A may be configured to execute all or a portion of the process blocks of process 200.

In process block 205, a depth sub-frame (e.g. depth acquisition 263A) is captured with a first region of depth pixels (e.g. depth pixels in region 271) configured to image a first zone (e.g. zone 281) of a field illuminated by near-infrared illumination light (e.g. light 161).

In process block 210, a visible-light sub-frame (e.g. visible light acquisition 265A) is captured with a second region of image pixels (e.g. CMOS pixels in region 272) that is distanced from the first region of the depth pixels. The second region of the image pixels is configured to image a second zone of the field (e.g. zone 282) while the first region of the depth pixels images the first zone of the field while the near-infrared illumination light illuminates the first zone.

In process block 215, a second depth sub-frame (e.g. depth acquisition 263C) is captured with a second region of depth pixels (e.g. depth pixels in region 272) configured to image the second zone of the field illuminated by near-infrared illumination light in a second time period different from a first time period when the first zone of the field is illuminated by the near-infrared illumination light. For example, sub-frame 291 is in a different time period than sub-frame 292.

In process block 220, a second visible-light sub-frame (e.g. visible light acquisition 265C) is captured with a first region of image pixels that is distanced from the second region of the depth pixels. The first region of the image pixels is configured to image the first zone of the field while the second region of the depth pixels images the second zone of the field while the near-infrared illumination light illuminates the second zone.

In an implementation of process 200, the first region of depth pixels is interspersed with the first region of image pixels and the second region of depth pixels is interspersed with the second region of image pixels.

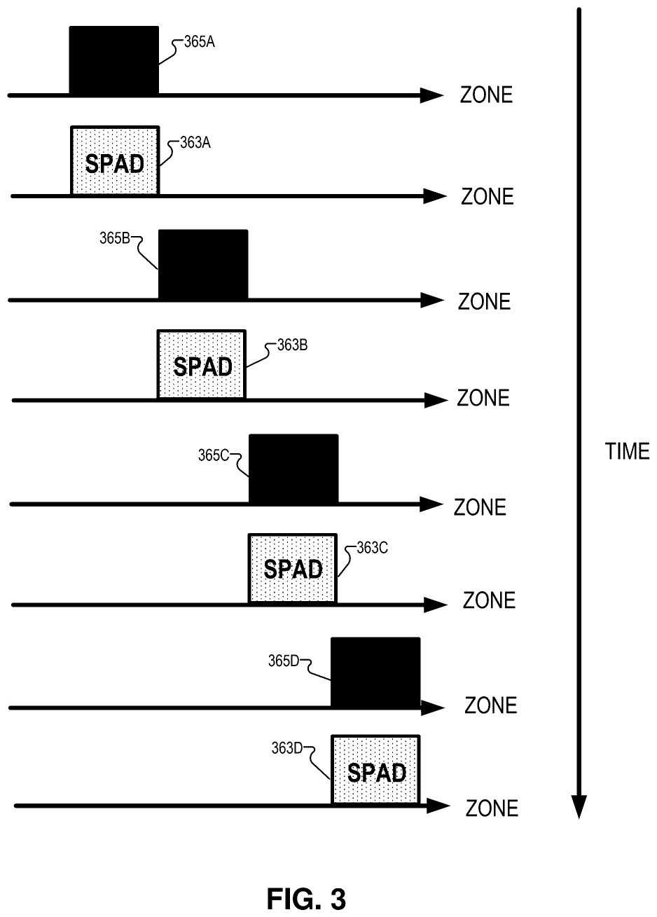

FIG. 3 illustrates another embodiment of example depth (SPAD) acquisition sub-frames 363A-363D and visible light imaging (CIS) acquisition sub-frames 365A-365D, in accordance with implementations of the disclosure. FIG. 3 illustrates that at any one time, either a depth zone is acquired or an image zone is acquired, or neither. Separating the acquisitions in time may further assist in preventing spectral crosstalk between the IR (SPAD) and RGB (CMOS) pixels. FIG. 2A illustrates that Depth acquisitions 263 may be captured in an overlapping time period as a visible light acquisitions 265. In contrast, FIG. 3 illustrates that, in some implementations, the Depth acquisitions 363 are captured in separate (not overlapping) time periods as visible light acquisitions 365. For example, Depth acquisition 363A is captured subsequent to visible light acquisition 365A and visible light acquisition 365B is captured subsequent to Depth acquisition 363A.

In some implementations, acquisition 363A and 365A are acquired by diagonal regions of sensor 270. For example, region 271 is diagonal from region 272 and region 273 is diagonal from region 274.

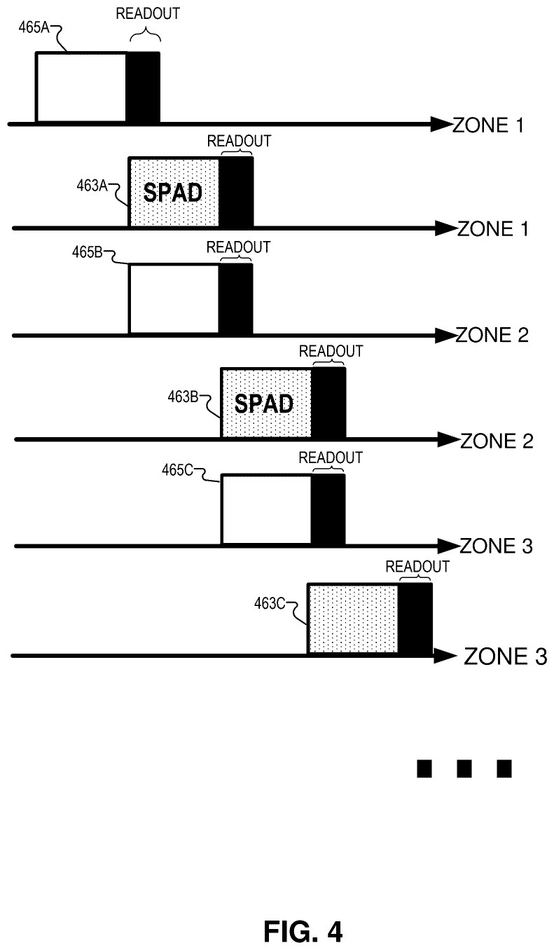

FIG. 4 illustrates another embodiment of example depth (SPAD) acquisition sub-frames 463A-463C and visible light imaging (CIS) acquisition sub-frames 465A-46C5, in accordance with aspects of the disclosure. In FIG. 4, the readout phase of one acquisition sub-frame overlaps with the acquisition phase of another acquisition sub-frame in the same zone.

In one embodiment, more than one depth zone is acquired simultaneously and more than one CIS zone is acquired simultaneously, as long as CIS and Depth zones are not acquired simultaneously. In an embodiment, zones 281 and 282 (but not zones 283 and 284) of FIG. 2B are illuminated with NIR light and regions 271 and 272 of imaging and depth sensor 270 acquire Depth data using the SPADs in the macropixels of regions 271 and 272 while regions 273 and 274 acquire RGB image data. Subsequently, zones 283 and 284 (but not zones 281 and 282) of FIG. 2B are illuminated with NIR light and regions 273 and 274 of imaging and depth sensor 270 acquire Depth data using the SPADs in the macropixels of regions 273 and 274 while regions 271 and 272 acquire RGB image data.

In one embodiment, an eye tracking module (e.g. eye-tracking module 180) identifies the direction the user is gazing. The controller (e.g. controller 107) instructs the light sources 163 in illumination module 160 to only illuminate one region, which correlates with the gaze direction. A corresponding region of interest (ROI) in the CMOS pixel array is activated while the rest of the array may remain unpowered. Alternately, only the ROI is activated in the SPAD array but the whole CIS array is active. These embodiments allow for low-power consumption.

In one embodiment, only one mode is on such that only depth pixels or CIS pixels are active at any one frame.

In one embodiment, an algorithm, implemented, for example, on a logic layer on the CMOS device, or on a processor or in an FPGA, further improves the image quality coming from the RGB array. In one embodiment, a machine learning algorithm provides a color correction to the distorted-color image, as well as a correction to the gray-level corresponding to each pixel. In one embodiment, an algorithm uses temporal and spatial values from the R, G, B and D pixels to provide these improvements.

In some implementations of the disclosure, the combined imaging and depth sensor 170/270 includes 3 wafer layers. The top wafer layer (Layer 1) is a backside illuminated (BSI) CIS layer which includes a CIS array interspersed with SPAD pixels. The middle layer (Layer 2) includes the control and processing circuitry for the dToF pixels. The bottom wafer layer (Layer 3) includes the control and processing circuitry for the CIS pixels. Note that “CIS layer” as used herein specifies the processing layers required to fabricate photodiodes and SPADs.

In one embodiment, an RGBI (Red-Green-Blue-Infrared) color filter array (CFA) is deposited above the pixel array. Red, green, and blue filters are deposited above CIS pixels and an infrared filter is deposited above the SPAD pixel. The spectral filters may be formed in various ways. Without loss of generality, in one embodiment, the filters may be formed by photolithographically patterning different light absorbing materials selectively on each pixel type. In one embodiment filters are formed by depositing and patterning layers of dielectric materials.

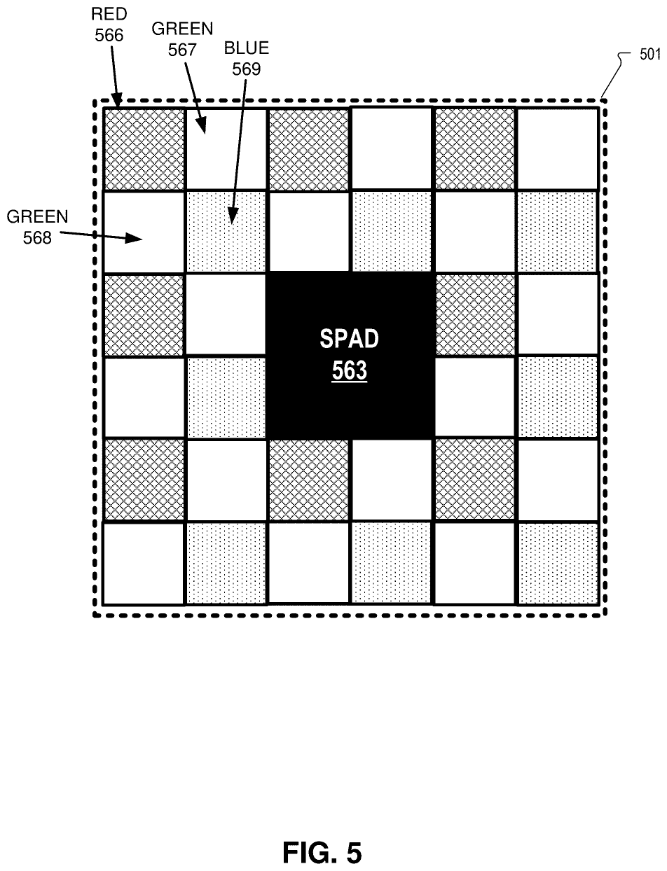

FIG. 5 illustrates an example macropixel 501 having a SPAD depth pixel 563 interspersed with CIS image pixels, in accordance with aspects of the disclosure. Image pixel 566 is a CMOS image pixel configured to sense red image light. Image pixels 567 and 568 are CMOS image pixels configured to sense green image light. Image pixel 569 is a CMOS image pixel configured to sense blue image light. Image pixels 566, 567, 568, and 569 are arranged in a Bayer pattern, in the illustrated implementation, although other configurations are possible. The Bayer pattern is repeated around SPAD depth pixel 563, in example macropixel 501. Macropixel 501 may be repeated tens, hundreds, or even thousands of times in combined imaging and depth sensors 170/270. In FIG. 5, the red image pixels are indicated by diagonal crosshatch fill, green image pixels are indicated by white fill, and blue image pixels are indicated by sparse-dot fill.

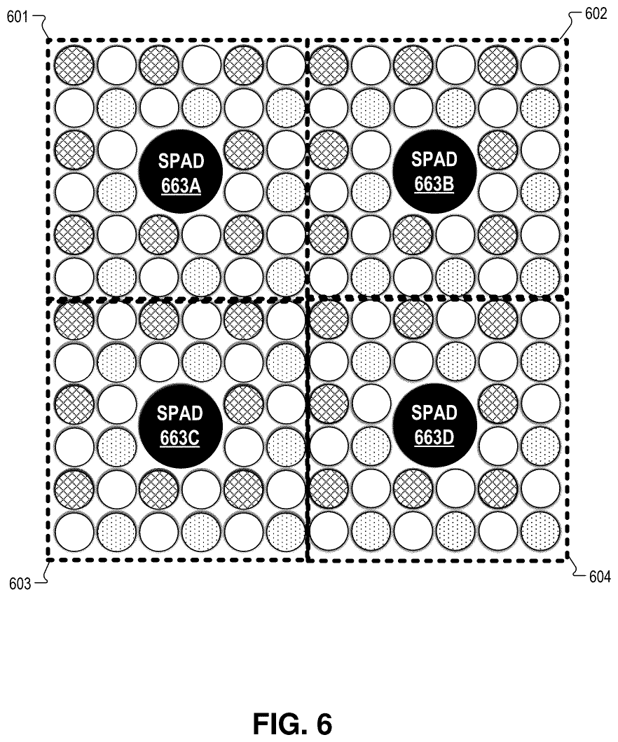

FIG. 6 illustrates corresponding instantaneous fields of view (iFoV) of pixels in 2×2 array of macropixels, in accordance with aspects of the disclosure. FIG. 6 illustrates four macropixels 601, 602, 603, and 604. Each macropixel 601, 602, 603, and 604 includes a SPAD pixel 663A, 663B, 663C, and 663D, respectively. SPAD pixel 663A, 663B, 663C, and 663D are interspersed among CMOS image pixels. In FIG. 6, the red CMOS image pixels are indicated by diagonal crosshatch fill, green CMOS image pixels are indicated by white fill, and blue CMOS image pixels are indicated by sparse-dot fill.

In one embodiment, the CIS layer of a combined imaging and depth sensor includes an array of macropixels with at least one color splitter on top of each. Light splitting structures typically include subwavelength building blocks. The light splitting structures may include metasurfaces having subwavelength nanostructures that are smaller than the wavelength of light the metasurfaces are configured to operate on. The unique feature of these structures is that they do not reject out-of-band light. Rather, they direct different spectral bands to separate processing circuitry. Thus, essentially all photons are collected, resulting in an increased collection efficiency when compared to traditional filters that absorb certain bands of light. NIR light can also be split by this type of light splitting structure.

One type of macropixel may include an array of RGB or RGBI (Red, Green, Blue, and Infrared) CIS pixels with a common color splitter for the visible bandpass. Another type of macropixel may include a mixed array of CIS pixels and a ToF pixel, and a color splitter which directs some light bands into the respective CIS pixels and VCSEL-band light (e.g. 850 nm or 940 nm) into the SPAD pixel.

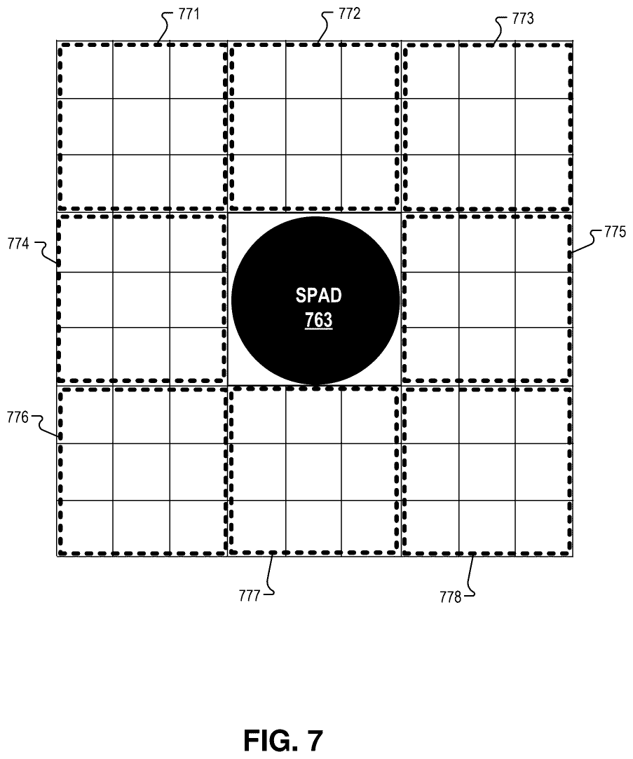

FIG. 7 illustrates a SPAD pixel 763 surrounded by CIS macropixels 771, 772, 773, 774, 775, 776, 777, and 778, in accordance with aspects of the disclosure. Macropixels 771-778 are illustrated as having nine CMOS image pixels, but more or fewer image pixels may be included in the macropixels. SPAD pixel 763 may include a microlens configured to focus near-infrared light to the photosensor of SPAD pixel 763. The CIS pixels in macropixels 771-778 may be illuminated via a light splitter (as described in an earlier section) to enhance light collection. It should be understood that, while the figure shows R, G, B CIS pixels, other spectral bands (e.g. infrared) may be used in macropixels 771-778.

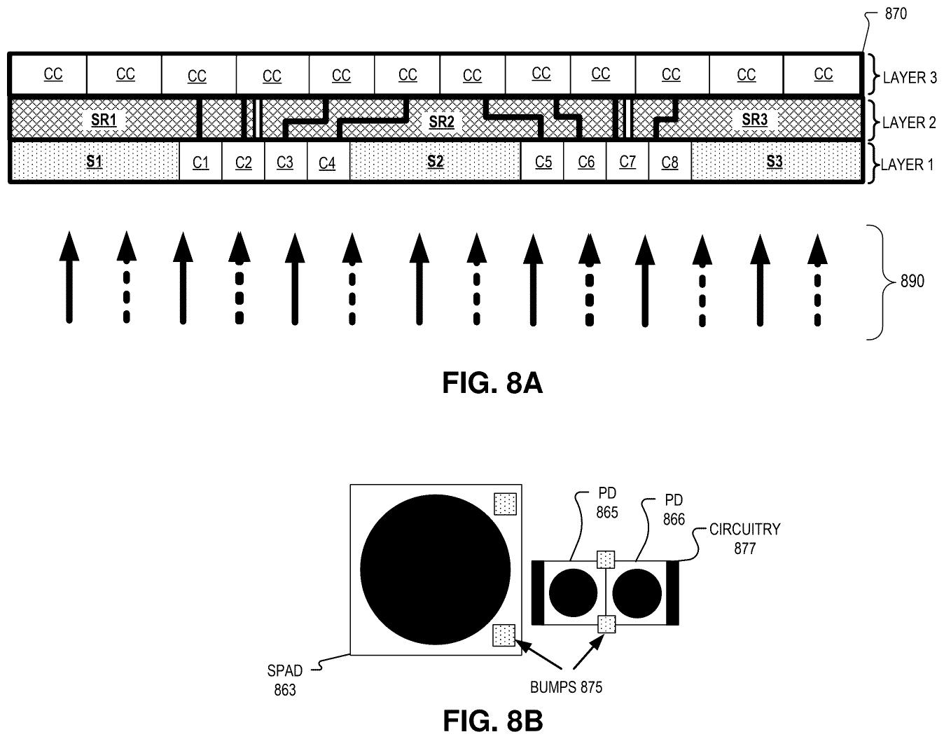

FIG. 8 illustrates an example imaging and depth sensor 870 including multiple layers, in accordance with aspects of the disclosure. Layer 1 of an imaging and depth sensor may also include pixel-level interconnects to layer 2 of the imaging and depth sensor.

In one embodiment, Layer 1 wafer is backgrounded to optimize sensitivity to photons while also reducing pixel-to-pixel cross-talk and the temporal response of the sensor (minimizing charge carrier diffusion by applying an electric field and keeping the absorption layer sufficiently thin). Additional structures such as Deep Trench Isolation may be formed between the SPADs and CIS devices or between macropixels to further reduce crosstalk. Layer 1 includes macropixels including depth pixels interspersed with image pixels. SPAD pixels S1, S2, and S3 are configured to image NIR illumination light included in scene light 890. Layer 1 also includes image pixels C1, C2, C3, C4, C5, C6, C7, and C8 configured to image visible light included in scene light 890.

Layer 2 may include the control and processing circuitry for the SPAD pixels S1, S2, and S3. In FIG. 8A, control and processing circuitry SR1 provides control and processing circuitry for SPAD S1, control and processing circuitry SR2 provides control and processing circuitry for SPAD S2, and control and processing circuitry SR3 provides control and processing circuitry for SPAD S3. Unlike traditional SPAD-only dual-tier sensors, here the processing circuitry per SPAD pixel may occupy an area larger than the area of a SPAD pixel but smaller than the area of a macropixel that includes both a SPAD pixel and CMOS pixels. For example, SR3 has a larger area than S3, but SR3 may be smaller than a macropixel that includes SR3 and surrounding image pixels. Such circuitry (SR1, SR2, and SR3) may include active or passive quenching circuit, active or passive recharge circuitry, buffer and logic elements, memory cells, decoupling capacitors or any other circuitry necessary to process or control the SPAD devices. Layer 2 also includes interconnects (e.g. Through-Silicon-Vias or TSV) which pass signals from the CIS pixels in Layer 1 to control circuitry (“CC”) in Layer 3.

FIG. 8B illustrates a top view of a SPAD 863 and photodiodes 865 and 866 of CIS pixels that may be included in imaging and depth sensor 870, in accordance with aspects of the disclosure. FIG. 8B shows contact bumps 875 and circuitry 877 that may be included in layer 1 of sensor 870. Circuitry 877 may include “3T” or “4T” CMOS image pixel circuitry, for example.

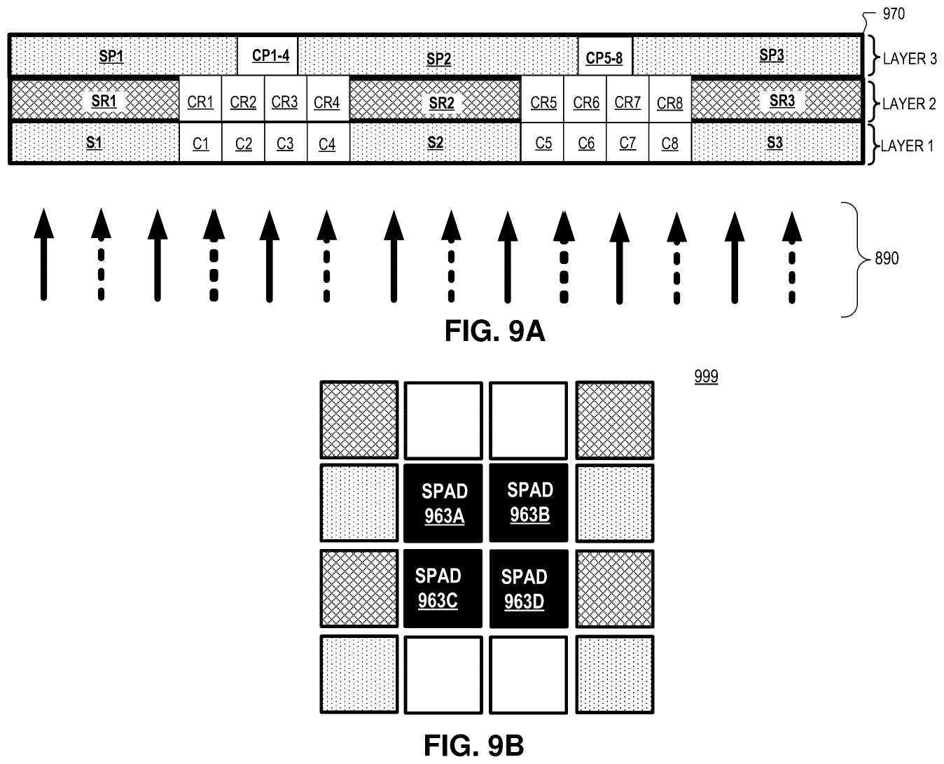

FIG. 9A illustrates another example imaging and depth sensor 970 including multiple layers, in accordance with aspects of the disclosure. In one embodiment, Layer 1 (bottom wafer) includes the SPADs and CIS pixels. Layer 1 includes macropixels of depth pixels interspersed with image pixels. SPAD pixels S1, S2, and S3 are configured to image near-infrared illumination light included in scene light 890. Layer 1 also includes image pixels C1, C2, C3, C4, C5, C6, C7, and C8 configured to image visible light included in scene light 890.

Layer 2 includes the front-end transistors which buffer the sensing node capacitance of each CIS or SPAD pixel from the capacitance of downstream circuitry and interconnects. Layer 3 includes circuitry (typically digital and memory) required to process each pixel's information. In this embodiment, the capacitance needed to be driven by both the CIS and SPAD pixels is drastically reduced or even minimized. While Layer 2 structures approximately match the pitch of Layer 1 pixels in the imaging and depth sensor of FIG. 9A, Layer 3 structures do not need to. Specifically, since the area required to process the TCSPC ToF pixel is much larger than that of a CIS pixel, more processing area than the area of the SPAD pixel can be allocated to it. In one embodiment, all processing of the CIS pixels is performed in Layer 2, and Layer 3 is dedicated to per-pixel processing and control of the SPAD array signals.

In one embodiment, the area of the SPAD pixel on Layer 1 is similar to that of the CIS pixel in layer 1. In one embodiment, the SPAD pixel area is larger. In one embodiment, the SPAD pixel is implemented as a compound pixel. For example, four SPAD diodes are laid out in a 2×2 configuration.

FIG. 9B illustrates an example compound pixel 999 having four SPAD pixels 963A-963D arranged in a 2×2 configuration with CIS pixels around the 2×2 configuration, in accordance with aspects of the disclosure. Each of the SPAD pixels 963A, 963B, and 963C, and 963D (collectively referred to as SPAD pixels 963) may be activated, quenched, and/or recharged alone or together with some or all of its neighbors. The output of each of the four SPAD pixels 963A-963D may be sampled together by the same circuit (e.g., a buffer or gate of one or more transistors), or uniquely by separate circuits. However, the TCSPC processing of the information from all four SPADs is done jointly. This enables a number of desirable features:
(1) It is sometimes desirable to maintain the same pixel pitch across an array. Since SPAD pixels tend to be larger than CIS pixels, implementing a compound SPAD can enable maintaining the same pitch of interconnects and other structures on Layer 1. Compound pixel 999 has the CIS pixels having the same pitch as the SPAD pixels 963.
(2) It is sometimes easier to form smaller microlenses. Having four small microlenses rather than one large one may ease the manufacturing process. Hence, the same microlenses may be used for the SPAD pixels and CIS pixels.
(3) It is sometimes desirable to reduce the current consumption of the sensor array. In certain cases, such as high depth signal, it is possible to only activate some of the SPADs in a compound pixel, thus reducing power consumption.
(4) In case of a defect which affects only one of the four SPAD pixels 963, a control circuitry may disable the defective SPAD, without losing coverage of the solid angle images by the 4-SPAD array.
(5) In some embodiments, it may be possible to operate each of the 4 SPADs in each pixel sequentially, thus achieving 4× the angular resolution of depth within the macropixel's iFoV.

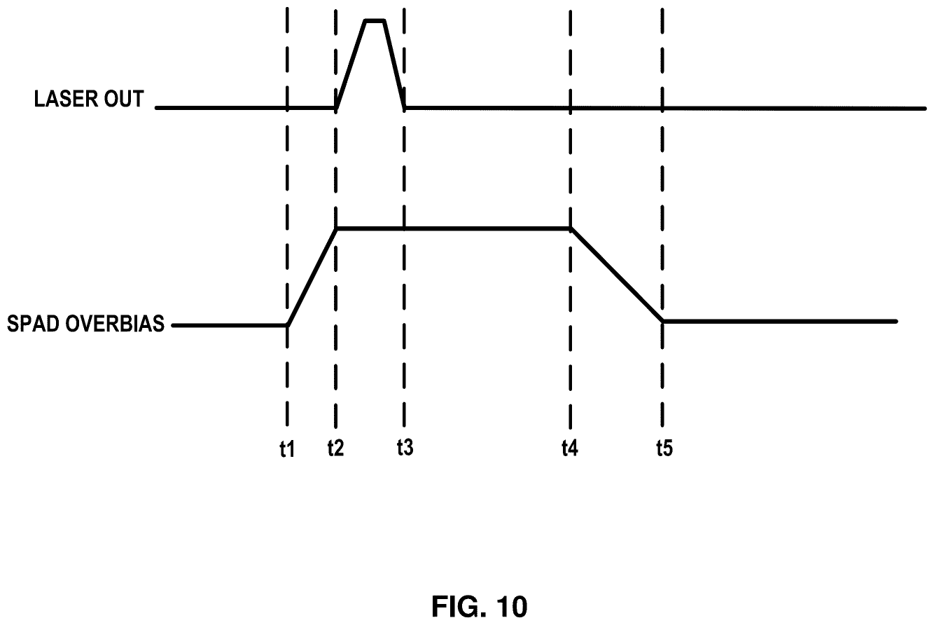

FIG. 10 illustrates an example temporal operation of a SPAD pixel or group of pixels, in accordance with aspects of the disclosure. A sufficient time before t2, the CIS pixels imaging the field of illumination which is about to be illuminated (CIS-subarray), are deactivated and their readout phase begins. At t1, the corresponding SPAD sub-array imaging the same zone is recharged such that it is essentially fully charged at t2 when the laser sub-array starts emitting light. The laser sub-array shifts off at t3. The SPAD sub-array collects times-of-arrival until t4. t4-t2 corresponds to the round trip time to the farthest target to be imaged. By time t5, the SPAD sub-array is deactivated by biasing it below its breakdown voltage.

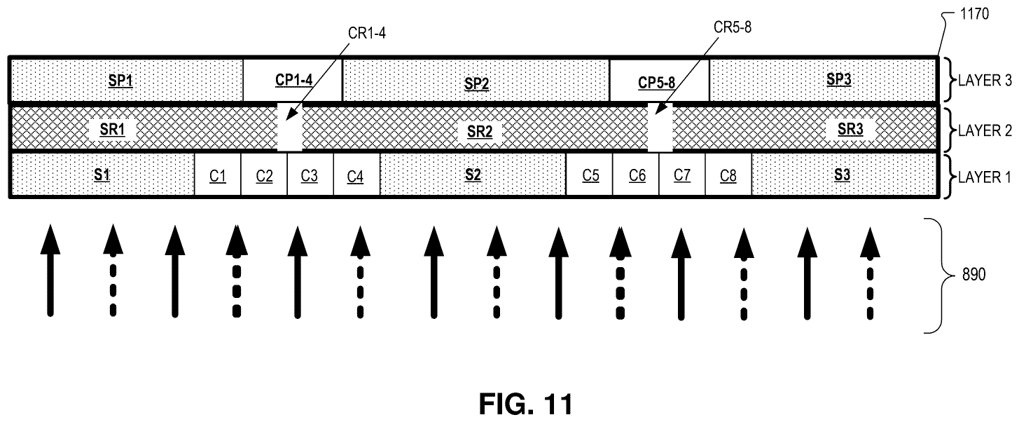

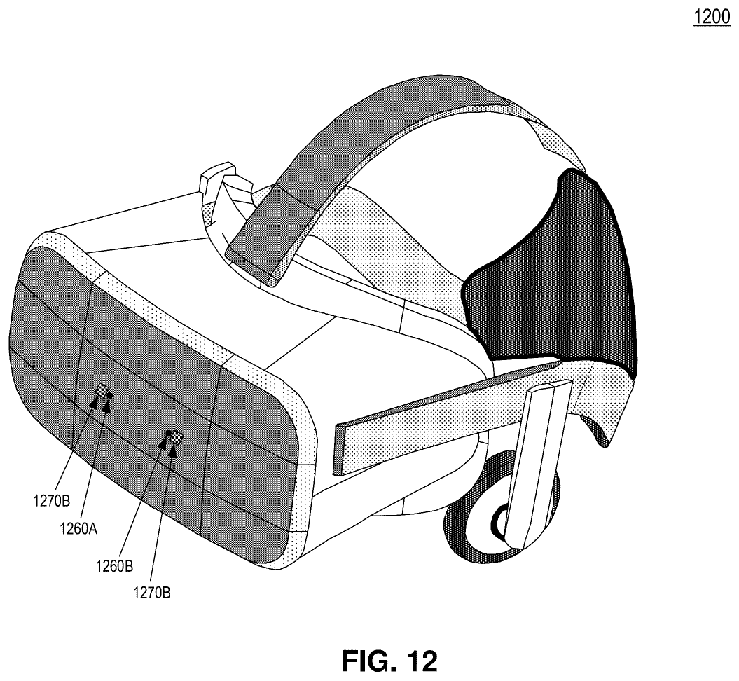

FIG. 11 illustrates another example imaging and depth sensor 1170 including multiple layers, in accordance with aspects of the disclosure. In one embodiment, the SPAD circuitry in Layer 2 (labeled SR in FIG. 11) contains the circuitry in closest proximity to the associated SPAD device, for example, the quenching and recharging circuitry as well as a buffering circuit to isolate the SPAD junction capacitance from processing circuitry input capacitance.

In FIG. 11, SPAD circuitry SR1 corresponds to SPAD S1, SPAD circuitry SR2 corresponds to SPAD S2, and SPAD circuitry SR3 corresponds to SPAD S3. The SPAD circuitry “SR” may be described as depth-processing circuitry for processing depth-signals generated by the SPAD depth pixels. The depth-processing circuitry may occupy an area of the second layer that is larger than the (SPAD) depth-pixel area (e.g. S1, S2, or S3) of the depth pixel in a given macropixel and smaller than macro-area of a given macropixel in the first layer. In an embodiment, the depth-processing circuity includes at least one of a quenching circuits, recharge circuit, or decoupling capacitors to support reading out the depth pixels in a given macropixel. The physical proximity of one or more of the components of the depth-processing circuitry to the depth pixel in Layer 1 may be important for the timeliness of reading out the depth data.

In the example of FIG. 11, the depth-processing circuitry SR2 occupies an area in Layer 2 that is larger than its corresponding (SPAD) depth pixel S2, yet, depth-processing circuitry SR2 is still smaller than the macro-area of the macropixel of the first layer since the macropixel that S2 is included in includes visible light (CIS) pixels C3, C4, C5, and C6. Region CR1-4 may be disposed between depth-processing circuitry (SR1 and SR2) in order to route imaging signals from the CIS pixels (e.g. pixels C1-C4) to layer 3 for readout and image processing. Similarly, region CR5-8 may be disposed between depth-processing circuitry (SR2 and SR3) in order to route imaging signals from the CIS pixels (e.g. pixels C5-C8) to layer 3.

In FIG. 11, region SP1 is for circuitry related to depth pixel S1, region SP2 is for circuitry related to depth pixel S2, and region SP3 is for circuitry related to depth pixel S3.

In an embodiment, Layer 2 may also contain power connections for the SPAD and associated circuitry. The SPAD regions (e.g. SP1, SP2, or SP3) in Layer 3 may contain circuitry required to collect and process time-of-arrival statistics and/or photon-counts for the SPAD pixels (e.g. S1, S2, or S3). For example, that circuitry may include memory cells to store time-of-arrival histogram data, timing circuitry to control which memory sub-arrays (bins) are addressed with updated photon counts, photon counting circuitry, and/or circuitry to enable readout of the data from the pixel.

Optionally, Layer 3 may contain circuitry, such as digital logic, to enable interpolation of imaging and/or depth data in the spatial domain or the spectral domain or the temporal domain, or the fusion of this data, such that each solid angle in the FOV is assigned an RGB as well as a depth value, even if the physical data has not been sensed by the system. In one embodiment, this processing is carried out in a processing device off-chip or in software. In one embodiment, the interpolated data may follow a geometrical algorithm, such as a linear interpolation. In one embodiment, the interpolated data may be based on a complex algorithm such as a machine learning algorithm.

The physical layout of the disclosed combined image and depth sensors in FIGS. 8, 9, and 11 may provide enough chip real estate so that each SPAD pixels has its own processing circuitry (rather than sharing the circuitry among SPADs). This may then allow for image and depth sensors to execute a global shutter for the depth pixels and the image pixels to simultaneously capture (or close to simultaneously capture) visible light imaging data and depth data (using the depth pixels) in a same frame.

As explained above, it is undesirable for out-of-band light to reach the SPADs, since this may either blind or reduce the SNR of the depth measurement. It is also undesirable for IR light which is transmitted by the module-level filter, to reach the RGB pixels, via the spectral filter or splitter. In one embodiment, an estimate of this IR light may be provided by the system in order to subtract the mean value of this IR light level from the RGB measurement. It is understood that the shot noise of that level cannot be subtracted. In one embodiment, the IR light level is estimated via an IR sensor which quantifies the light flux at the same spectral passband of the module filter. In one embodiment, one or more SPAD elements is used to estimate the in-band IR-light ambient flux, either globally or locally in the array. IR light subtraction from the RGB signal may either be performed on-chip or off-chip.

In one embodiment, the RGBD module is integrated in a Virtual Reality (VR), mixed reality (MR) or augmented reality (AR) headset. In one implementation, the RGBD frame (the processed, fused, and interpolated frame) is used to project the 2D image from the camera position to that of one or both eyes of the user. In one embodiment, two such modules are used, and projection is done for each respective eye. These projections may then be rendered to a display of an HMD.

FIG. 12 shows that imaging and depth sensors 1270A and 1270B may be placed on head mounted display (HMD) 1200 at a location that approximates where a pupil of an eye would be looking through, when a user is wearing HMD 1200, in accordance with aspects of the disclosure. Illumination modules 1260A and 1260B may be co-located in or near imaging and depth sensors 1270A and 1270B in order to facilitate ToF functionality. Placing the imaging and depth sensors 1270A and 1270B near the pupil (or at least inline with a gaze of the pupil as the user gazes in a forward direction) may be advantageous so that any imaging or depth sensing done by the sensor is from the same/similar perspective as the user and thus any re-projection/display of the environment to the user will be from a more realistic perspective.

In one embodiment the RGBD frames generated by sensors 870, 970, or 1170 are used to generate realistic occlusions, i.e., to determine whether synthetic objects which interact with the real scene should occlude or be occluded by imaged objects.

In one embodiment the RGBD frame generated by sensors 870, 970, or 1170 is used to map out the environment in the vicinity of the user, for example to prevent collisions or to calculate the position of superimposed synthetic objects.

In one embodiment, the module is integrated into AR glasses, and the frame information is used to generate synthetic/virtual objects which are then projected onto the eye or eyes, so as to appear realistic in 3D space.

In an implementation of the disclosure, a combined image and depth sensor includes a first layer, a second layer, and a third layer. The first layer includes macropixels of depth pixels interspersed with image pixels. The image pixels are configured to image visible light and the depth pixels are configured to image near-infrared illumination light. The second layer includes depth-processing circuitry for processing depth-signals generated by the depth pixels. The depth-processing circuitry occupies an area of the second layer that is larger than a depth-pixel area of the depth pixel in a given macropixel and smaller than a macro-area of the given macropixel in the first layer. The third layer includes image-processing circuitry to process image signals received from the image pixels of the macropixels. The second layer is disposed between the first layer and the third layer and the image signals propagate from the first layer, through the second layer, to reach the third layer.

In an implementation, the depth-processing circuity includes at least one of a quenching circuit, a recharge circuit, or decoupling capacitors to support reading out the depth pixels in the macropixel.

In an implementation, histogram memory cells are disposed in the third layer and the histogram memory cells are configured to store time-of-flight (TOF) data captured by the depth pixels.

The combined image and depth sensor may further include interpolation processing logic configured to interpolate the depth-signals and the image signals to generate dense data. The points in the dense data include (1) red, green, and blue intensities; and (2) range information. Generating the dense data may include a machine learning algorithm fusing the depth-signals and the image signals to generate the dense data. The points in the dense data may include confidence levels associated with the range information and each point in the dense data may further include an angular position of the data point.

In an implementation, the combined image and depth sensor is configured to execute a global shutter for the depth pixels and the image pixels.

In another implementation, a system includes a combined image and depth sensor and interpolation processing logic. The combined image and depth sensor includes a first layer and a second layer. The first layer includes macropixels of depth pixels interspersed with image pixels. The image pixels are configured to image visible light and the depth pixels are configured to image near-infrared illumination light. The second layer includes depth-processing circuitry for processing depth-signals generated by the depth pixels. The interpolation processing logic is configured to interpolate the depth-signals and image signals to generate dense data. The image signals are received from the image pixels of the macropixel and points in the dense data include (1) red, green, and blue intensities; and (2) range information. The interpolation processing logic is included in the combined image and depth sensor, in some implementations. The interpolation processing logic is separately packaged from the combined image and depth sensor, in some implementations. The image pixels are complementary metal-oxide-semiconductor (CMOS) pixels and the depth pixels are Single Photon Avalanche Diode (SPAD) pixels, in some implementations.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

The term “processing logic” (e.g. processing logic 109) in this disclosure may include one or more processors, microprocessors, multi-core processors, Application-specific integrated circuits (ASIC), and/or Field Programmable Gate Arrays (FPGAs) to execute operations disclosed herein. In some embodiments, memories (not illustrated) are integrated into the processing logic to store instructions to execute operations and/or store data. Processing logic may also include analog or digital circuitry to perform the operations in accordance with embodiments of the disclosure.

A “memory” or “memories” described in this disclosure may include one or more volatile or non-volatile memory architectures. The “memory” or “memories” may be removable and non-removable media implemented in any method or technology for storage of information such as computer-readable instructions, data structures, program modules, or other data. Example memory technologies may include RAM, ROM, EEPROM, flash memory, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device.

Networks may include any network or network system such as, but not limited to, the following: a peer-to-peer network; a Local Area Network (LAN); a Wide Area Network (WAN); a public network, such as the Internet; a private network; a cellular network; a wireless network; a wired network; a wireless and wired combination network; and a satellite network.

Communication channels may include or be routed through one or more wired or wireless communication utilizing IEEE 802.11 protocols, short-range wireless protocols, SPI (Serial Peripheral Interface), I²C (Inter-Integrated Circuit), USB (Universal Serial Port), CAN (Controller Area Network), cellular data protocols (e.g. 3G, 4G, LTE, 5G), optical communication networks, Internet Service Providers (ISPs), a peer-to-peer network, a Local Area Network (LAN), a Wide Area Network (WAN), a public network (e.g. “the Internet”), a private network, a satellite network, or otherwise.

A computing device may include a desktop computer, a laptop computer, a tablet, a phablet, a smartphone, a feature phone, a server computer, or otherwise. A server computer may be located remotely in a data center or be stored locally.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible non-transitory machine-readable storage medium includes any mechanism that provides (i.e., stores) information in a form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A method comprising:
capturing a depth sub-frame with a first region of depth pixels configured to image a first zone of a field illuminated by near-infrared illumination light; and
capturing a visible-light sub-frame with a second region of image pixels that is distanced from the first region of the depth pixels, wherein the second region of the image pixels is configured to image a second zone of the field while the first region of the depth pixels images the first zone of the field while the near-infrared illumination light illuminates the first zone.

2. The method of claim 1 further comprising:
capturing a second depth sub-frame with a second region of depth pixels configured to image the second zone of the field illuminated by near-infrared illumination light in a second time period different from a first time period when the first zone of the field is illuminated by the near-infrared illumination light; and
capturing a second visible-light sub-frame with a first region of image pixels that is distanced from the second region of the depth pixels, wherein the first region of the image pixels is configured to image the first zone of the field while the second region of the depth pixels images the second zone of the field while the near-infrared illumination light illuminates the second zone.

3. The method of claim 2, wherein the first region of depth pixels is interspersed with the first region of image pixels, and wherein the second region of depth pixels is interspersed with the second region of image pixels.

4. An imaging and depth system comprising:
an illumination module configured to emit near-infrared illumination light;
an array of image pixels configured to image visible light;
depth pixels interspersed with the image pixels, wherein the depth pixels are configured to image the near-infrared illumination light emitted by the illumination module; and
processing logic configured to:
drive the illumination module to illuminate a first zone of a field with the near-infrared illumination light;
capture a depth sub-frame with a first region of the depth pixels configured to image the first zone of the field illuminated by the near-infrared illumination light; and
capture a visible-light sub-frame with a second region of the image pixels that is distanced from the first region of the depth pixels, wherein the second region of the image pixels is configured to image a second zone of the field while the first region of the depth pixels images the first zone of the field while the near-infrared illumination light illuminates the first zone.

5. The imaging and depth system of claim 4, wherein the processing logic is further configured to:
drive the illumination module to illuminate a second zone of a field with the near-infrared illumination light;
capture a second depth sub-frame with a second region of the depth pixels configured to image the second zone of the field illuminated by the near-infrared illumination light in a second time period different from a first time period when the first zone of the field is illuminated by the near-infrared illumination light; and
capture a second visible-light sub-frame with a first region of image pixels that is distanced from the second region of the depth pixels, wherein the first region of the image pixels is configured to image the first zone of the field while the second region of the depth pixels images the second zone of the field while the near-infrared illumination light illuminates the second zone.

6. The imaging and depth system of claim 5, wherein the first region of depth pixels is interspersed with the first region of image pixels, and wherein the second region of depth pixels is interspersed with the second region of image pixels.

7. The imaging and depth system of claim 5, wherein the depth sub-frame and the visible-light sub-frame are included in a first sub-frame, and wherein the second depth sub-frame and the second visible-light sub-frame are included in a second sub-frame.

8. The imaging and depth system of claim 7, wherein the first sub-frame and the second sub-frame are processed into a frame, and wherein the first sub-frame and the second sub-frame are captured within 20 ms of another.

9. The imaging and depth system of claim 4, wherein the illumination module only illuminates the first zone of the field, and not other zones of the field, while the depth sub-frame and the visible-light sub-frame is being captured.

10. A combined image and depth sensor comprising:
a first layer including macropixels of depth pixels interspersed with image pixels, wherein the image pixels are configured to image visible light and the depth pixels are configured to image near-infrared illumination light;
a second layer including depth-processing circuitry for processing depth-signals generated by the depth pixels, wherein the depth-processing circuitry occupies an area of the second layer that is larger than a depth-pixel area of the depth pixel in a given macropixel and smaller than a macro-area of the given macropixel in the first layer; and
a third layer that includes image-processing circuitry to process image signals received from the image pixels of the macropixels, wherein the second layer is disposed between the first layer and the third layer, and wherein the image signals propagate from the first layer, through the second layer, to reach the third layer.

11. The combined image and depth sensor of claim 10, wherein the depth-processing circuity includes at least one of a quenching circuits, recharge circuit, or decoupling capacitors to support reading out the depth pixels in the macropixel.

12. The combined image and depth sensor of claim 10, wherein histogram memory cells are disposed in the third layer, wherein the histogram memory cells are configured to store time-of-flight (TOF) data captured by the depth pixels.

13. The combined image and depth sensor of claim 10, wherein the combined image and depth sensor is configured to execute a global shutter for the depth pixels and the image pixels.

14. The combined image and depth sensor of claim 10 further comprising:
interpolation processing logic configured to interpolate the depth-signals and the image signals to generate dense data, wherein points in the dense data includes (1) red, green, and blue intensities; and (2) range information.

15. The combined image and depth sensor of claim 14, wherein the interpolation processing logic is included in the combined image and depth sensor.

16. The combined image and depth sensor of claim 14, wherein the interpolation processing logic is separately packaged from the combined image and depth sensor.

17. The combined image and depth sensor of claim 14, wherein the image signals are received from the image pixels of the macropixel.

18. The combined image and depth sensor of claim 14, wherein generating the dense data includes a machine learning algorithm fusing the depth-signals and the image signals to generate the dense data.

19. The combined image and depth sensor of claim 18, wherein the points in the dense data include confidence levels associated with the range information, and wherein each point in the dense data further includes an angular position of the point in the dense data.

20. The combined image and depth sensor of claim 10, wherein the image pixels are complementary metal-oxide-semiconductor (CMOS) pixels, and wherein the depth pixels are Single Photon Avalanche Diode (SPAD) pixels.
